(19) United States
(12) Patent Application Publication
(10) Pub. No.: US 2018/0097621 A1
(43) Pub. Date: Apr. 5, 2018

(54) OBFUSCATED SECRET KEY DERIVATION FOR NON-SECURE COMMERCIAL OFF-THE-SHELF (COTS) DEVICES

(71) Applicant: Sony Interactive Entertainment America LLC, San Mateo, CA (US)

(72) Inventor: BRYAN COTTA, San Mateo, CA (US)

(21) Appl. No.: 15/282,039

(22) Filed: Sep. 30, 2016

(51) Int. Cl. H04L 9/08; H04L 9/10

(52) U.S. Cl. CPC H04L 9/0816; H04L 9/10

(57) ABSTRACT

One or more device-specific serial numbers are processed by a chaotic function to render an output, which is used to derive at least one encryption key.

### FIELD

The application relates generally to obfuscated secret key derivation for non-secure commercial off-the-shelf (COTS) devices.

### BACKGROUND

Securing devices almost always requires the use of secret values that can be used as keys or key material. Most commercial-off-the-shelf (COTS) devices do not have a secure means in which to store secret values that can be uses as key material.

### SUMMARY

Present principles bridges the above gap in an easily deployable manner without incurring the enormous cost of a per-device-unique Physically Unclonable Function (PUF). Readily accessible device-unique values that are easy for the owner to obtain (e.g. serial numbers) but difficult for an adversary to guess are pulled from the device and used with an obfuscated key derivation function in order to yield device-unique key material. Keys derived from this key material can then be used to derive private keys for certificates, secret storage keys, or shared secret keys. Furthermore, since the key derivation function is rooted in chaos theory, the derived secret key has a great chance of being different if the function is replayed on different hardware. The techniques herein may be used for cloud services with a secure front and back end assets not requiring specialized (expensive) compliance measures, general information technology (IT) for securing infrastructure assets, mobile devices, tablets, gaming consoles, routers, printers, etc.

Accordingly, a device includes one or more computer memories that are not a transitory signal and that include instructions executable by at least one processor to input at least one device-specific serial number to a chaotic function. The instructions are executable to process an output of the chaotic function using a key derivation function (KDF) to produce key material M, and to use the key material M and/or a derivation thereof to encrypt information.

In some implementations, the instructions may be executable to input a seed value concatenated with the device-specific serial number to the chaotic function. In examples, the instructions may be executable to input the seed value along with the output of the chaotic function to the KDF.

In example embodiments the instructions are executable to derive at least one key from the key material M using a derivation KDF. The derivation KDF may be the same as the KDF producing the key material M or it may be a different KDF.

The chaotic function may be given by k(x_{N}) (1−(x_{N})), in which k in an example embodiment equals four.

In another aspect, a method includes processing at least one device-specific number using a chaotic function to render an output, and using the output of the chaotic function to derive at least one encryption key.

In another aspect, an apparatus includes a processor and storage accessible to the processor with instructions executable by the processor for processing one or more device-specific serial numbers using a chaotic function to render an output. The instructions are executable for using the output of the chaotic function to derive one or more encryption keys.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a schematic diagram of key derivation using a chaotic function; and

FIG. 3 is a flow chart of logic pertaining to FIG. 2.

### DETAILED DESCRIPTION

This disclosure relates generally to computer ecosystems including aspects of consumer electronics (CE) device networks such as but not limited to distributed computer game networks. A system herein may include server and client components, connected over a network such that data may be exchanged between the client and server components. The client components may include one or more computing devices including game consoles such as but not limited to Sony PlayStation™ and Microsoft Xbox™, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Orbis or Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access web sites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony Playstation (trademarked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C # or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

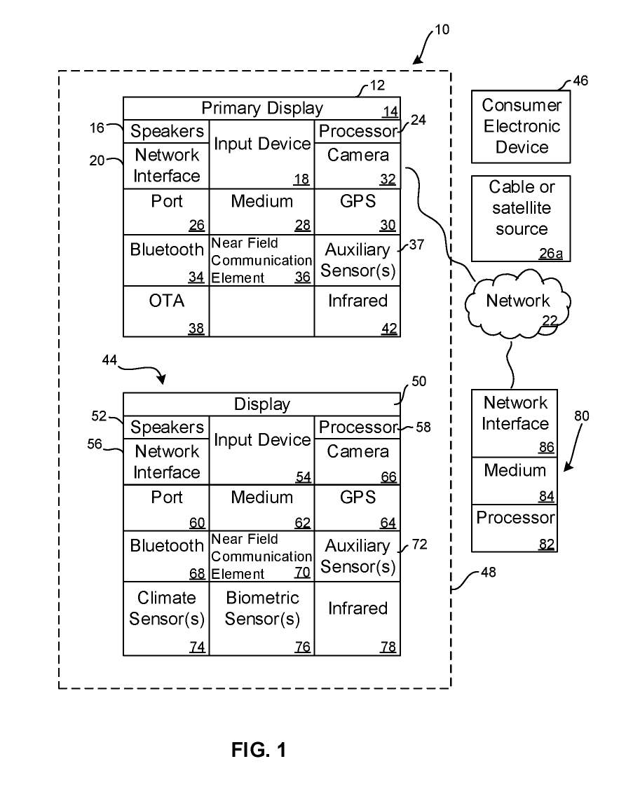

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTH TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used. As alluded to above, the CE device 44/46 and/or the source 26a may be implemented by a game console. Or, one or more of the CE devices 44/46 may be implemented by devices sold under the trademarks Google Chromecast, Roku, Amazon FireTV.

In the example shown, to illustrate present principles all three devices 12, 44, 46 are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVD 12, or it may be a more sophisticated device such as a tablet computer, a game controller communicating via wired or wireless link with a game console implemented by the second CE device 46 and controlling video game presentation on the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver. Typically, the server 80 includes multiple processors in multiple computers referred to as “blades”.

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

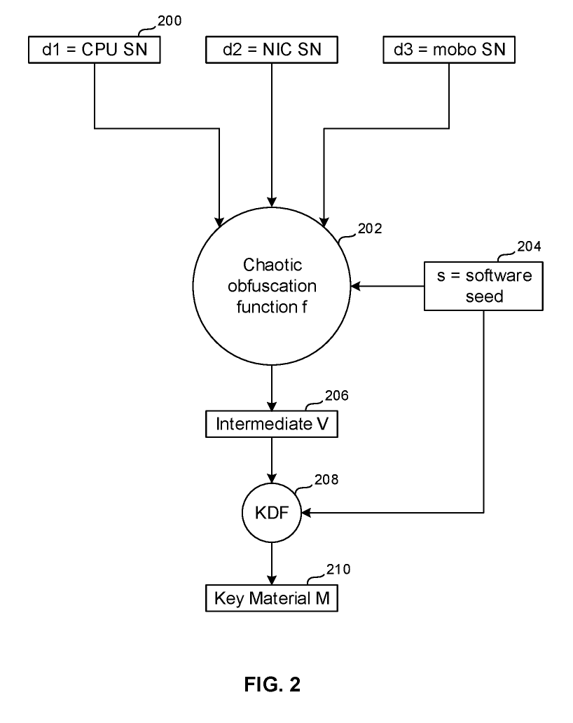

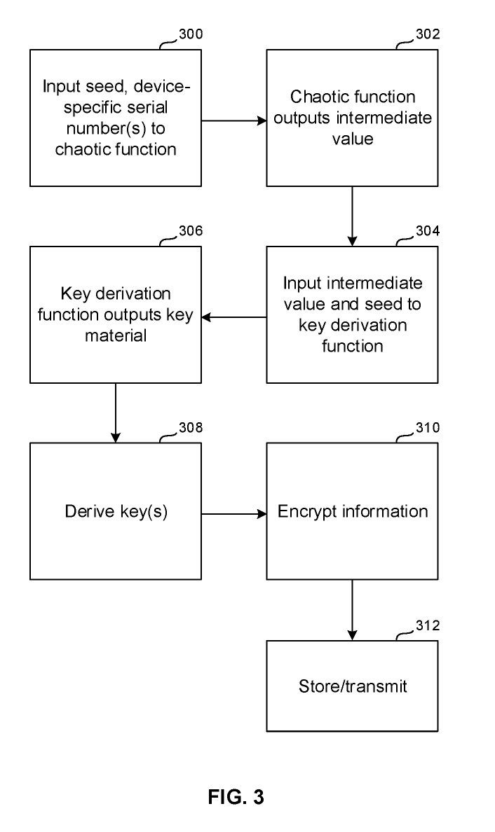

FIGS. 2 and 3 illustrate present principles for generating encryption keys for COTS devices using a chaotic function. In FIG. 2, one or more device-specific serial numbers 200 are input to a chaotic function 202, along with a preferably high entropy software seed 204 such as a pseudo-random number. The serial numbers 200 may include, for example, one or more of a device media access control (MAC) address, a device central processing unit (CPU) serial number, network interface controller (NIC) serial number, and a device motherboard serial number. The seed 204 and serial numbers 200 may be concatenated prior to input to the function 202 into a string x₀=seed, d₁, d₂, . . . dₙ.

The chaotic function 202 operating on the same input string x is defined to be chaotic in that the function likely will lead to different results if replayed on different hardware, owing to differences in round-off error between devices, round-off technique (e.g., round up, round down, truncate), etc. In an implementation, x_{N+1}=f(x_{N}), wherein f(x_{N})=k(x_{N}) (1−(x_{N})). In a specific example k=4.

An intermediate obfuscated value V=f (s, d₁, d₂, . . . , dₙ)is output at 206 by the function 202 and input to a key derivation function (KDF) 208 along with the seed 204. The KDF 208 outputs key material 210, also designated “M” (=KDF (V+s)). Example KDFs include, but are limited to, the set of hash-based KDFs in NIST SP 800-108 (http://csrc.nist.gov/publications/nistpubs/800-108/sp800-108.pdf).

The key material 210 is then used to derive one or more other keys including private keys, shared secret keys, storage encryption keys. These other keys may be derived from M using another KDF, or may be derived by iterating a counter in the KDF 208.

FIG. 3 further illustrates the principles above. At block 300 the seed “S” and one or more device-specific serial numbers are input to the chaotic function, which may iterate plural times, e.g., 1,000 times, each iteration setting “N” in f(x_{N}) in the chaotic function to be N+1. That is, for the first iteration:

x₁=f(x₀)=k(x₀) (1−(x₀)); for the second iteration, x₁ is operated on by the chaotic function to render x₂, and so on.

After iteration is complete, the intermediate value V is output at block 302 and input along with the seed “s” at block 304 to the KDF. At block 306 the KDF outputs the key material M. This key material M, if only a single key is to be used, may establish the needed key, or other keys may be derived from it at block 308 according to disclosure above. Designated information is then encrypted with the appropriate key from block 308 at block 310 and stored and/or transmitted in a secure, encrypted form at block 312. Decryption typically entails a reverse of the encryption process at block 310. Or, the key material or derivation thereof may be used internally to the device on which it is created, e.g., as a password.

It will be appreciated that whilst present principals have been described with reference to some example embodiments, these are not intended to be limiting, and that various alternative arrangements may be used to implement the subject matter claimed herein.

What is claimed is:

1. A device comprising:
at least one computer memory that is not a transitory signal and that comprises instructions executable by at least one processor to:
input at least one device-specific serial number to a chaotic function;
process an output of the chaotic function using a key derivation function (KDF) to produce key material M; and
use the key material M and/or a derivation thereof to encrypt information.

2. The device of claim 1, wherein the instructions are executable to input a seed value concatenated with the at least one device-specific serial number to the chaotic function.

3. The device of claim 2, wherein the instructions are executable to input the seed value along with the output of the chaotic function to the KDF.

4. The device of claim 1, wherein the instructions are executable to derive at least one key from the key material M using a derivation KDF.

5. The device of claim 4, wherein the derivation KDF is the KDF producing the key material M.

6. The device of claim 4, wherein the derivation KDF is not the KDF producing the key material M.

7. The device of claim 1, wherein the chaotic function=k(x_{N}) (1−(x_{N})).

8. The device of claim 7, wherein k=4.

9. The device of claim 1, comprising the at least one processor.

10. A method comprising:
processing at least one device-specific number using a chaotic function to render an output; and
using the output to derive at least one encryption key.

11. The method of claim 10, comprising processing a concatenation of the device-specific number and a seed using the chaotic function to render the output.

12. The method of claim 10, comprising inputting the output to a key derivation function (KDF) to render key material.

13. The method of claim 12, comprising using the key material to encrypt information.

14. The method of claim 12, comprising deriving at least one key from the key material, the key for encrypting information.

15. The method of claim 10, comprising encrypting information using at least one derivation of the output.

16. The method of claim 10, wherein the chaotic function=4(x_{N}) (1−(x_{N})).

17. An apparatus comprising:
a processor;
storage accessible to the processor and bearing instructions executable by the processor for:
processing at least one device-specific serial number using a chaotic function to render an output; and
using the output to derive at least one encryption key.

18. The apparatus of claim 17, wherein the chaotic function=k(x_{N}) (1−(x_{N})).

19. The apparatus of claim 18, wherein k=4.

20. The apparatus of claim 17, wherein the instructions are executable for inputting the output of the chaotic function to a key derivation function (KDF) to render key material.

21. The apparatus of claim 20, wherein the instructions are executable for using the key material to encrypt information.
